(19) United States
(12) Patent Application Publication
(10) Pub. No.: US 2007/0130696 A1
(43) Pub. Date: Jun. 14, 2007

(54) MECHANICALLY AND THERMALLY RESPONSIVE POLYMER YARN FOR INDUSTRIAL FABRIC APPLICATION

(75) Inventors: Dwight Payne, St. Simona Island, GA (US); Gilbert Ross, Waycross, GA (US); Heping Zhang, Summerville, SC (US); Antony Morton, Yorkshire (GB); Valentine Craig, Summerville, SC (US)

Correspondence Address: TAYLOR & AUST, P.C., 142 SOUTH MAIN STREET, P. O. BOX 560, AVILLA, IN, 46710, US

(73) Assignee: Voith Fabrics Patent GmbH

(21) Appl. No.: 11/623,973

(22) Filed: Jan. 17, 2007

Related U.S. Application Data
(63) Continuation of application No. 10/850,684, filed on May 21, 2004.

(51) Int. Cl. C11D 3/00

(52) U.S. Cl. 8/115.51

(57) ABSTRACT

Yarn for an industrial fabric which is subjected to a heat-set temperature during production, the yarn being made from a polymeric material, the polymeric material including a first phase and a second phase. The melting temperature of the second phase is equal to or less than the heat-set temperature and the melting temperature of the first phase is higher than the heat-set temperature.

### CROSS REFERENCE TO RELATED APPLICATIONS

This is a continuation of U.S. patent application Ser. No. 10/850,684 entitled “MECHANICALLY AND THERMALLY RESPONSIVE POLYMER YARN FOR INDUSTRIAL FABRIC APPLICATION”, filed May 21, 2004.

### BACKGROUND OF THE INVENTION

1. Field of the Invention

The present invention relates to yarns made of polymeric material for use in industrial fabrics.

2. Description of the Related Art

Industrial fabrics, especially papermaking fabrics, are typically but not exclusively made of a woven structure using polymer yarns in the weft and warp direction. To improve the smoothness and the printability of a paper sheet produced on a papermaking fabric it is desirable to increase the smoothness and the contact area of the paper contacting surface of the papermaking fabric. Especially for high speed applications it is further desirable to increase the smoothness of the wear side of the papermaking fabric in order to improve the aerodynamic performance of the fabric.

The smoothness of the paper contacting surface can be improved by increasing the yarn density. However, this results in increased manufacturing costs and reduced permeability of the fabric. Further, the smoothness can be improved by using profiled monofilament yarns having flat surfaces. When using the flat shaped yarns, such as warp yarns in float weave designs, the flat warp yarns provide greater surface contact area resulting in a larger impression against the paper sheet. For graphic and fine paper grades the large impression leads to undesirable sheet marking in the paper.

What is needed in the art is a structure and a method to bring the weft yarns as well as the warp yarns into the paper contacting surface of the papermaking fabric to increase the contact area and the smoothness of the fabric.

### SUMMARY OF THE INVENTION

It is the object of the present invention to provide polymer yarns suitable for use in industrial fabrics so as to overcome the disadvantages described above.

According a first aspect of the invention there is provided a yarn for an industrial fabric. Such an industrial fabric is subjected to a maximum heat-set temperature during production. The yarn according to the invention is made from a polymeric material. The polymeric material includes a first phase and a second phase. Further the melting temperature of the second phase is in the range of 90° C. to 260° C. and the melting temperature of the second phase is lower than the melting temperature of the first phase.

The idea of the invention is to provide a yarn having the ability for controllable deformation when subjected to mechanical tension and thermal heat, as is the case during heat-set treatment for industrial fabrics. Typical maximum heat-set temperatures are in the range of 90° C. to 260° C. The operational temperatures of the industrial fabrics are below the maximum heat-set temperature. The yarn, according to the present invention, is made from a polymeric material. The polymeric material includes two different phases, which have two different melting points. The melting temperature of the second phase is in the range of 90° C. to 260° C., which is within the range of the maximum heat-set temperatures. The melting temperature of the second phase is lower than the melting temperature of the first phase.

The present invention includes a yarn made from a polymeric material. The material has a melting temperature of the second phase that is equal to or less than the maximum heat-set temperature and the melting temperature of the first phase is higher than the maximum heat-set temperature during the heat-set treatment. As such the yarn, according to the present invention, softens during the heat-set treatment and becomes very deformable.

The yarns, according to the present invention, include weft yarns and warp yarns. During heat-set treatment the harder warp yarns compress the softer and deformable weft yarns resulting in a crimp interchange between the warp yarns and the weft yarns, leading to a reduction of the warp knuckles, thereby giving the fabric an enhanced surface smoothness.

Further, the industrial fabric is operated on a papermaking machine at a maximum operation temperature. Therefore according to one embodiment of the present invention the melting temperature of the second phase is higher than the maximum operating temperature.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIGS. 1a and 1b show a comparison between the paper contacting surface of a dryer fabric made from standard yarn material and a dryer fabric made from yarn material according to the invention;

FIGS. 2a and 2b show the difference in contact area between paper supported on the dryer fabric according to the invention and paper supported on a standard dryer fabric; and

FIGS. 3a and 3b show the difference in crimp level between the weft yarns of the dryer fabric according to the invention and a standard dryer fabric.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

According to one embodiment of the present invention the polymeric material is a polymer blend wherein the first phase includes a first polymer component and wherein the second phase includes a second polymer component and wherein the first and the second polymer component are immiscible. By blending immiscible polymer compounds most of the properties, such as the melting temperature of each polymer compound, will be substantially maintained.

In one embodiment of the present invention the first and the second phase are of the same material and differ in their state of aggregation.

Depending on the application the maximum operational temperature for an industrial fabric is less than 90° C. or less 120° C. For papermaking fabrics the maximum heat-set temperatures are in the ranges as follows:

Forming: 170° C. to 190° C., typically 180° C. to 185° C.

Press: 160° C. to 185° C., typically 160° C. to 165° C.

Dry: 180° C. to 220° C., typically 190° C.

Therefore the melting temperature of the second phase/second polymer component is in the range of 120° C. to 220° C., preferably in the range of 160° C. to 220° C.

By way of an example, the fabric of the present invention is subjected to a heat-set treatment with a maximum temperature of 190° C. and is operated at a maximum operational temperature of 120° C. Therefore, the melting temperature of the second phase of a yarn, according to the present invention, must be lower than 190° C. and higher than 120° C., e.g. 170° C. for Polyvinylidene Fluoride (PVDF). The melting temperature of the first phase of this yarn is more than 190° C., e.g. 253° C. for Polyethylene Terephthalate (PET).

According to a further embodiment of the present invention the melting temperature of the second phase/second polymer component is at least 30° C. lower than the melting temperature of the first phase/first polymer component.

Further, the first component includes any of the following, either alone or blended: homepolymers and copolymers of the polyesters, homepolymers and copolymers of polyarnides, and Polyphenylene Sulfide (PPS). In addition the second component includes any of the following, either alone or blended: polyolefins, polyarnides and fluoropolymers.

It has been found that yarns, according to the present invention, showing the best deformability, at the heat-set temperature for which they are designed, is a blend including between 51% and 99% by weight, preferably between 60% and 95% by weight, of the first component and between 49% and 1% by weight, preferably between 5% and 40% by weight, of the second component.

In one embodiment of the present invention the polymer blend is processed by incorporating at least one suitable compatibilizer. Without a suitable compatibilizer the mechanical properties, such as toughness of the yarn produced is reduced. Further for immiscible polymer blends the so called “die swell” during extrusion increases, which effects the controllability of the extruded yarn diameter.

It has been found that the best results, in regard to processability, can be achieved if the at least one compatibilizer is included in an amount of 0.01% to 10% by weight, preferably in an amount of 0.1 to 5% by weight.

There are different types of compatibilizers that are suitable for the polymer blend. According to an embodiment of the present invention at least one compatibilizer is a physical compatibilizer. A physical compatibilizer is based on the principle that components of the compatibilizer are miscible with each component/phase of the blend. Thus, the compatibilizer acts as a polymeric surfactant.

According to a further embodiment of the present invention the physical compatibilizer is any of the following: Ethylene Methyl Acrylate Copolymer (EMA), and Ethylene Butyl Acrylate Copolymer (EBA). By way of example, the blend includes the polymer components Polyethylene (PE), PET and the compatibilizer EMA. In this case the ethylene component of the compatibilizer is miscible with the PE and the methacrylate component of the compatibilizer is miscible with the PET.

A suitable compatibilizer also can be a reactive compatibilizer. This method of compatibilization relies on the chemical reaction between the functional group that is grafted onto the PE and the end groups of the PET. This results in the in-situ formation of a PET/PE copolymer, which then acts as a physical compatibilizer for the blend. The suitable reactive compatibilizer can be any of the following: Ethylene-g-Maleic Anhydride Copolymers, Ethylene-g-Glycidal Methacrylate.

Further, the polymer blend can include at least one suitable stabilizer. A stabilizer, for example, is added to design yarns with the ability to withstand severe conditions such as high temperature and/or high humidity. According to one embodiment of the present invention, the at least one stabilizer is a hydrolysis stabilizer. Hydrolysis stabilizers are added to the blend to generate yarns for use under high humidity conditions. The hydrolysis stabilizer can be a carbodiimide compound of either monomeric, polymeric or a combination composition.

According to a further embodiment of the present invention the at least one stabilizer can be an anti-oxidation stabilizer. Anti-oxidation stabilizers are added to the blend to generate yarns for use under high temperature conditions.

It has been found that the best results in retaining the properties of the blend can be achieved if the at least one stabilizer is included in an amount of 0.1% to 10% by weight, preferably in an amount of 0.5 to 5% by weight.

According to an embodiment of the present invention, the yarn material has a elongation at yield point 1, which is greater than 5% and/or an elongation at yield point 2, which is greater than 20%.

Further, the yarn, according to the present invention, is preferably a monofilament yarn but also can be a multifilament yarn.

The yarn, according to the present invention, has a diameter in the range of 0.20 mm to 2.0 mm, preferable in the range of 0.4 mm to 1.0 mm. These diameters are suitable for most of the different types of papermaking fabrics.

According to a further embodiment of the present invention, the shape of the yarn is round or profiled, with, for example, chamfered edges.

It has been found that the paper contacting surface of the fabric has an enhanced smoothness over the paper contacting surfaces of prior art papermaking fabrics leading to less sheet marking, if the ratio of the crimp level of the warp yarns to the crimp level of the weft yarns is as low as possible. Therefore, according to another aspect of the present invention, there is provided an industrial fabric having a set of weft yarns and a set of warp yarns. The warp yarns and the weft yarns are interwoven with each other and have a crimp level after heat-set treatment. During heat-set treatment a tension in the range of 1 kN/m to 6 kN/m, preferably 1.5 kN/m to 5 kN/m and a temperature in the range of 90° C. to 260° C., preferably 160° C. to 220° C. is applied to the warp yarns. At least one warp yarn and at least one weft yarn have a crimp level ratio which is less than 4. The crimp level for each yarn is the difference of the length, along the crimped line of the yarn, and the length along the straight line of the yarn, divided by the length along the straight line of the yarn.

This aspect of the invention is explained, by way of example, as follows: During heat-set treatment, tension and temperature is applied to the warp yarns. At least some of the weft yarns are made from a material, which softens at the maximum heat-set temperature and therefore is very deformable at the maximum heat-set temperature. Further, the warp yarns are made from a material, which softens less than the weft yarns at the maximum heat-set temperature. The fact that the weft yarns are made from the material, which softens more during heat-set treatment than the warp yarns, allows the harder warp yarns to compress the softer weft yarns, thereby reducing the warp knuckles, which leads to a smoother fabric.

The crimp level is calculated with the following formula:
(length along the crimped line of the yarn−length along the straight line of the yarn)/length along the straight line of the yarn*100=crimp level in %

By way of example for a given yarn, the length along the crimped line of the yarn is 12 cm and the length along the straight line is 10 cm. Therefore the crimp level is (12cm-10 cm) /10 cm*100=20%. It is desirable if the ratio of the crimp level of at least one warp yarn to the crimp level of at least one weft yarn is less than 3.5, preferably less than 3.0, most preferably less than 2.0.

According to yet another aspect of the present invention there is provided an industrial fabric including, at least in part, yarns made from a polymeric material, wherein the industrial fabric has been subjected to a heat-set temperature during production. The polymeric material includes a first phase and a second phase, and the melting temperature of the second phase is equal to or less than the heat-set temperature with the melting temperature of the first phase being higher than the heat-set temperature.

According to a further embodiment of the present invention the yarns made of polymeric material having two phases are weft and/or warp yarns.

Further, it is desirable if the industrial fabric is utilized as a papermaking fabric, preferably a forming or a dryer fabric. In the case of a dryer fabric the dryer fabric has an air permeability in the range from 50 to 200 cfm, preferably in the range from 75 to 150 cfm.

The following examples are intended to illustrate the invention, not to limit it.

TABLE 1

| Composition | Reference | Sample 1 | Sample 2 | Sample 3 | Sample 4 |
|---|---|---|---|---|---|
| Component 1 | 100% PET | 98% PET | 95% PET | 91% PET | 87.3% PET |
| Component 2 | — | 2% PE | 5% PE | 5% PE | 5% PE |
| Additive 1 | — | — | — | 1% Anti- | 0.5% Anti- |
| | | | | Oxidant | Oxidant |
| Additive 2 | — | — | — | 3% Compat- | 3% Compat- |
| | | | | ibilizer | ibilizer |
| Additive 3 | — | — | — | — | 1.2% |
| | | | | | Hydrolysis |
| | | | | | stabilizer |
| Melting temp. | 253 | 253 | 253 | 253 | 253 |
| phase 1 [° C.] | | | | | |
| Melting temp. | — | 120 | 120 | 120 | 120 |
| phase 2 [° C.] | | | | | |
| Tenacity [gpd] | 2.9 | 3.1 | 2.9 | 2.8 | 3.1 |
| Elongation at | 45 | 47 | 46 | 54 | 45 |
| break [%] | | | | | |
| Young's Modulus | 72 | 71 | 70 | 63 | 60 |
| [gpd] | | | | | |
| Shrinkage [%] | 15 | 15.8 | 17 | 12 | 11 |
| Strength retained | 69 | 63 | 38 | 30 | 85 |
| [%] after | | | | | |
| hydrolysis at | | | | | |
| 140° C., 24 hours | | | | | |
| Strength retained | 46 | 44 | 51 | 54 | 80 |
| [%] after dry heat | | | | | |
| at 204° C., | | | | | |
| 24 hours | | | | | |

Each of the different components are added as a percentage of weight.

Table 1 shows a comparison between a standard PET monofilament yarn (Reference) and monofilament yarns according to the invention (Sample 1 to Sample 4) each having the same yarn diameter (0.7 mm) as the reference yarn.

As can be seen in Table 1, the yarns of samples 1 to 4 have two melting temperatures. A melting temperature of the first phase, which is 253° C. and a melting temperature of 120° C. for the second phase. Therefore, the yarn, according to the present invention, has a melting temperature (120° C.) which is in the temperature range of typical heat-set treatments (90° C. to 220° C.) and a melting temperature, which is higher than the heat-set temperature.

Samples 1 through 4 are made from a polymer blend including the polymer components PET and PE. The first phase is formed by the PET polymer component and the second phase is formed by the PE polymer component. PET and PE are immiscible polymers and therefore generate a blend with two phases.

As can be seen, samples 1, 2 and 4 have approximately the same mechanical properties as the reference sample. Sample 1 has the same degradation resistance as the reference sample. To improve the processability, samples 3 and 4 include 3% of a compatibilizer. To improve the resistance to dry heat treatment, sample 3 further includes 1% of an anti-oxidation stabilizer. As can be seen the strength retained after dry heat treatment is increased to 54%.

To improve hydrolysis resistance, sample 4 further includes a hydrolysis stabilizer in an amount of 1.2%. As can be seen from Table 1, sample 4 has the best dry heat and wet heat resistance behaviour.

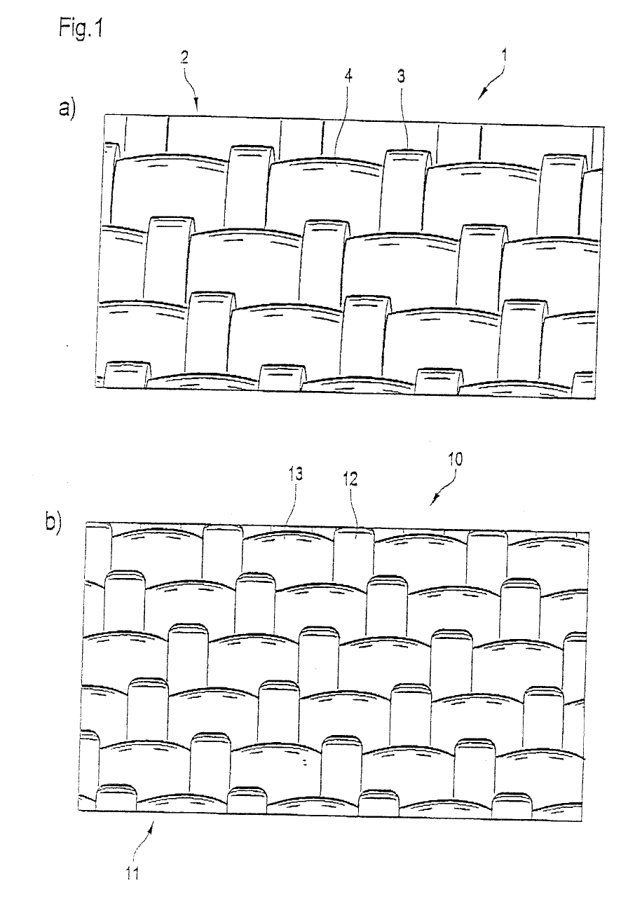

FIG. 1 illustrates the paper contacting surface 2 of a dryer fabric 1 made from standard yarn material and the paper contacting surface 11 of a dryer fabric 10 made from yarn material, according to the present invention.

It has to be noted that both fabrics 1 and 10 have the same weave design and that the weft and the warp yarns of both fabrics have the same diameter. Further both fabrics are manufactured identically, at least in terms of the heat-set treatment, which had been performed by applying a tension in the range of 1.5 kN/m to 5 kN/m to the warp yarns with a temperature in the range of 170° C. to 220° C.

FIG. 1a shows the paper contacting surface 2 of fabric 1 having warp 3 and weft 4 yarns made from 100% PET.

FIG. 1b shows a paper contacting surface 11 of fabric 10 having warp yarns 12 made from 100% PET and having weft yarns 13 made from a PET-PE polymer blend according to the present invention.

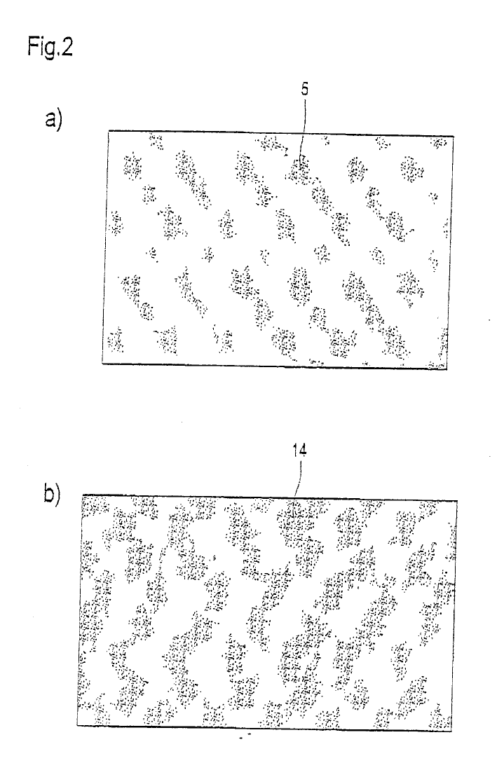

As can be seen in FIG. 1a weft yarns 4 of fabric 1 substantially extend in a straight line having a low crimp level. Measurements have shown a crimp level in the 4% range. In contrast thereto, warp yarns 3 have a high crimp level, which is approximately 19%. Therefore the paper contacting surface 2 of dryer fabric 1 only has a contact area 5 of 22%, as shown in FIG. 2a, with a crimp level ratio of warp yarn to weft yarn of 4.75.

As can be seen in FIG. 1b weft yarns 13 of fabric 10 extend in a crimped line having a high crimp level compared with the crimp level of weft yarns 4 illustrated in FIG. 1a. Measurements have shown a crimp level of wefts 13 is in the 5.5% range. Further, warp yarns 12 have a lower crimp level than warp yarns 3 of dryer fabric 1. The crimp level of warps 12 is approximately 10%. Therefore, the paper contacting surface 11 of dryer fabric 10 has an enhanced contact area 14 of 30%, as shown in FIG. 2b. This compares to contact area 5 of dryer fabric 1 which is 22%, as shown in FIG. 2a. According to the invention the crimp level ratio of warp yarn to weft yarn is 1:8.

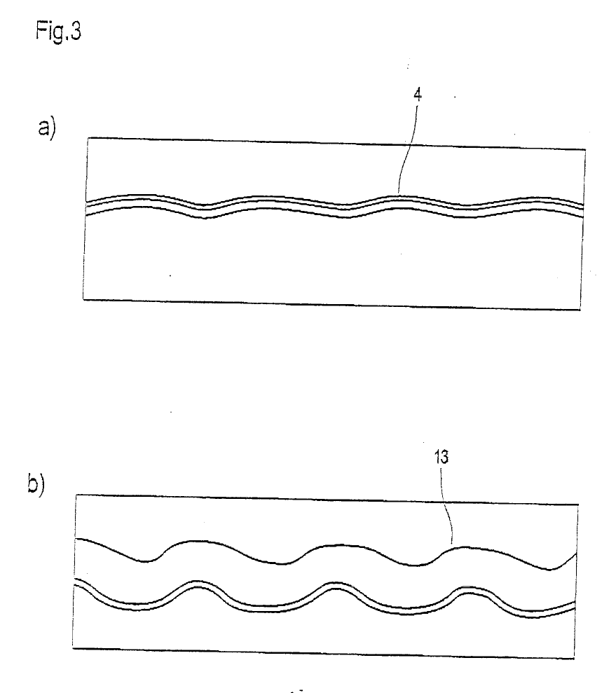

FIG. 3 shows the difference in crimp level between a weft yarn 13 of dryer fabric 10, according to the present invention, and a weft yarn 4 of standard dryer fabric 1.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A woven papermaking fabric, wherein the fabric has been subjected to a heat set treatment during manufacture, said fabric including at least in part a plurality of yarns made from a polymeric material, wherein the polymeric material has two immiscible phases, wherein the first phase has a first melting temperature and the second phase has a second melting temperature, wherein the second melting temperature of the second phase is less than or equal to the maximum heat set temperature and wherein the first melting temperature of the first phase is greater than the maximum heat set temperature, wherein the first phase includes at least one of homopolymers of polyesters, copolymers of polyesters and polyphenylene sulfide, and wherein said second phase includes a polyolefin.

2. The woven papermaking fabric of claim 1, wherein the fabric has a maximum operation temperature, said second melting temperature of said second phase being higher than said maximum operation temperature.

3. The woven papermaking fabric of claim 1, wherein said second phase is an amorphous phase, said second melting temperature being a softening temperature.

4. The woven papermaking fabric of claim 1, wherein said second phase of said polymeric material has a second melting temperature in the range of between approximately 90° C. to 260° C.

5. The woven papermaking fabric of claim 4, wherein said second melting temperature is in the range of between approximately 120° C. to 220° C.

6. The woven papermaking fabric of claim 5, wherein said second melting temperature is in the range of between approximately 160° C. to 220° C.

7. The woven papermaking fabric of claim 1, wherein said second melting temperature is at least 30° C. lower than said first melting temperature.

8. The woven papermaking fabric of claim 1, wherein said first phase and said second phase are mixed together to form a polymeric blend, said blend including between approximately 51% and 99% by weight of said first phase and between approximately 49% and 1% by weight of said second phase.

9. The woven papermaking fabric of claim 8, wherein said polymeric blend further comprises at least one compatibilizer.

10. The woven papermaking fabric of claim 9, wherein said compatibilizer is a part of said polymeric blend in an amount of between approximately 0.01% to 10% by weight.

11. The woven papermaking fabric of claim 10, wherein said compatibilizer is a part of said polymeric blend in an amount of between approximately 0.1% to 5% by weight.

12. The woven papermaking fabric of claim 9, wherein said compatibilizer is a physical compatibilizer.

13. The woven papermaking fabric of claim 12, wherein said physical compatibilizer includes at least one of Ethylene Methyl Acrylate Copolymer and Ethylene Butyl Acrylate Copolymer.

14. The woven papermaking fabric of claim 9, wherein said compatibilizer is a reactive compatibilizer.

15. The woven papermaking fabric of claim 14, wherein said reactive compatibilizer includes at least one of Ethylene-g-Maleic Anhydride Copolymers and Ethylene-g-Glycidal Methacrylate.

16. The woven papermaking fabric of claim 8, wherein said polymeric blend further comprises at least one stabilizer.

17. The woven papermaking fabric of claim 16, wherein said stabilizer is a part of said polymeric blend in an amount of between approximately 0.01% to 10% by weight.

18. The woven papermaking fabric of claim 17, wherein said stabilizer is a part of said polymeric blend in an amount of between approximately 0.1% to 5% by weight.

19. The woven papermaking fabric of claim 16, wherein said at least one stabilizer is a hydrolysis stabilizer.

20. The woven papermaking fabric of claim 19, wherein said hydrolysis stabilizer is a carbodiimide compound.

21. The woven papermaking fabric of claim 16, wherein said at least one stabilizer is an anti-oxidation stabilizer.

22. The woven papermaking fabric of claim 1, wherein said polymeric material has at least one of an elongation at yield point of greater than approximately 5% and an other yield point of greater than approximately 20%.

23. The woven papermaking fabric of claim 1, wherein the yarn is a monofilament.

24. The woven papermaking fabric of claim 1, wherein the yarn is a multifilament.

25. The woven papermaking fabric of claim 1, wherein the yarn has a diameter in the range of approximately 0.20 mm to approximately 2.0 mm.

26. The woven papermaking fabric of claim 25, wherein said diameter is in the range of between approximately 0.4 mm to 1.0 mm.

27. The woven papermaking fabric of claim 1, wherein the yarn is one of round and profiled.

28. The woven papermaking fabric of claim 27, wherein the yarn is profiled having chamfered edges.

29. The woven papermaking fabric of claim 1, wherein said plurality of yarns include at least one of a weft yarn and one of a warp yarn.

30. The woven papermaking fabric of claim 1, wherein at least one of said plurality of yarns is pulled during a heat-set treatment resulting in a crimp level in the range of between approximately 4.0% to 6.5%.

31. The woven papermaking fabric of claim 1, wherein the fabric is formed into a papermaking fabric including one of a forming fabric, a dryer fabric and a base of a press fabric.

32. The woven papermaking fabric of claim 31, wherein the fabric is a dryer fabric having a permeability in the range of between approximately 50 cfm to 200 cfm.

33. The woven papermaking fabric of claim 32, wherein said permeability is in the range of between approximately 75 cfm to 150 cfm.

34. A process of making a woven papermaking fabric, comprising the steps of:
forming a polymeric material, wherein the polymeric material has two immiscible phases, wherein the first phase has a first melting temperature and the second phase has a second melting temperature, wherein the second melting temperature of the second phase is less than or equal to the maximum heat set temperature of the woven papermaking fabric and wherein the first melting temperature of the first phase is greater than the maximum heat set temperature, wherein the first phase includes at least one of homopolymers of polyesters, copolymers of polyesters and polyphenylene sulfide, and wherein said second phase includes a polyolefin;
forming a yarn from said polymeric material; and
forming a woven papermaking fabric from said yarn, wherein the fabric has been subjected to a heat set treatment during manufacture.
